(19) United States
(12) Patent Application Publication
(10) Pub. No.: US 2023/0417163 A1
(43) Pub. Date: Dec. 28, 2023

(54) CDA OPERATION-INTERLOCKED OIL JET SYSTEM

(71) Applicants: HYUNDAI MOTOR COMPANY, SEOUL (KR); KIA CORPORATION, SEOUL (KR)

(72) Inventor: Seung-Woo Shin, Hwaseong-si (KR)

(21) Appl. No.: 17/978,499

(22) Filed: Nov. 1, 2022

(30) Foreign Application Priority Data
Jun. 28, 2022 (KR) 10-2022-0079127

(51) Int. Cl. F01M 1/16; F01M 1/08; F01M 9/10

(52) U.S. Cl. CPC F01M 1/16; F01M 1/08; F01M 9/10; F01M 2250/60

(57) ABSTRACT

A CDA operation interlocked oil jet system connects the OCV for supplying the oil for the operation of the CDA of the rocker arm and the oil jet check valve configured to perform the oil jet injection toward the piston of the engine by the bypass oil extension line, and includes the control unit configured to control the OCV so that the bypass oil extension line is open when the CDA is operated, so that it is possible to control the oil jet injection by dividing the bypass function of the OCV into the operation and non-operation of the CDA to use the bypass function of the OCV accordingly, and in particular, the oil jet injection to the cylinder is performed when the CDA is not operated, and then stopped in the deactivated cylinder that occurs when the CDA is operated, so that it is possible to prevent the oil-up phenomenon and reduce the capacity of the oil pump by reducing or blocking the unnecessary injection oil of the oil jet.

### CROSS REFERENCE TO RELATED APPLICATIONS

This application claims priority to Korean Patent Application No. 10-2022-0079127, filed on Jun. 28, 2022, which is incorporated herein by reference in its entirety

### BACKGROUND

### Field of the Disclosure

The present disclosure relates to an oil jet system, and particularly, to a CDA operation-interlocked oil jet system controlled so that an oil is not injected into a deactivated cylinder by an operation of a CDA.

Description of Related Art

### In general, an engine for a vehicle includes a cylinder deactivation (CDA) system and an oil jet system.

For example, the CDA system includes a rocker arm device, and the rocker arm device includes a rocker arm, a rocker pin positioned inside a rocker arm mechanism, and an oil control valve (OCV) for controlling the oil supply to the rocker pin from an outside of the rocker arm.

Accordingly, the operation of the CDA causes the oil supplied from the oil control valve to convert the rocker pin to a disengaged state by a hydraulic operation, so that the rocker arm is separated by a lost motion to place the corresponding cylinder in a deactivated state, whereas a non-operation of the CDA causes the rocker pin to return to an engaged state by a spring restoring force in a state in which a hydraulic pressure is released by stopping the oil supply, so that the corresponding cylinder is operated by the coupling of the rocker arm.

In addition, the oil jet system injects the oil supplied from an oil gallery of the engine into the cylinder through a check valve and an oil jet, and thus is operated so that a piston reciprocating in the cylinder where combustion occurs is cooled by the action of oil.

Accordingly, the CDA system functions to improve fuel efficiency of a vehicle and increase a temperature increase effect of the vehicle, and the oil jet system functions to cool the piston reciprocating in the cylinder from combustion heat.

However, the oil jet system is operated in a regular oil injection method without distinction between the operation and non-operation of the CDA system.

Accordingly, a non-combustion situation of the deactivated cylinder according to the CDA operation does not require the oil injection of the oil jet into the cylinder for cooling the piston, but the oil injection of the oil jet is performed in the same manner as a combustion cylinder, and the oil unnecessarily injected into the deactivated cylinder is bonded to a liner of the engine.

As a result, the injected oil bonded to the liner forms a negative pressure, thereby increasing the possibility of the occurrence of oil-up in which the oil moves up toward a combustion chamber formed by a piston.

The contents described in Description of Related Art are to help the understanding of the background of the present disclosure, and may include what is not previously known to those skilled in the art to which the present disclosure pertains.

### SUMMARY

Accordingly, an object of the present disclosure considering the above points is to provide a CDA operation-interlocked oil jet system, which may control the injection of an oil jet by dividing a bypass function of an OCV into an operation and non-operation of the CDA to use the bypass function of the OCV accordingly, and in particular, cause the oil jet injection into the cylinder to be performed when the CDA is not operated and then to be stopped in a deactivated cylinder caused by the operation of the CDA, so that it is possible to reduce or block the unnecessary injection oil of the oil jet, thereby reducing a capacity of an oil pump as well as preventing an oil-up phenomenon.

In order to achieve the object, an oil jet system according to the present disclosure includes an oil jet check valve configured to perform an oil jet injection toward a piston of an engine, a bypass oil extension line connecting the oil jet check valve to an OCV for supplying an oil to a rocker arm, and configured to send a bypass oil discharged from the OCV to the oil jet check valve by a bypass function conversion of the OCV, and a control unit configured to control the OCV so that the bypass oil extension line is blocked by a bypass opening of the OCV when a CDA of the rocker arm is operated, and control the OCV so that the bypass oil extension line is open by a bypass closing of the OCV when the CDA is not operated.

In an embodiment, the bypass oil extension line is connected to a bypass oil line through which the bypass oil is discharged from the OCV, and the connection path having a vertical direction in which gravity acts so that the bypass oil freely drops is formed in a cylinder block of the engine so as to be connected from the OCV to the oil jet check valve.

In an embodiment, the bypass oil extension line is formed in a semi-circular cross-sectional cylinder block groove formed in a structure integrated with the cylinder block by being recessed in the cylinder block of the engine or a hollow cross-sectional pipe that is a separate component connected to the oil jet check valve outside the engine.

In an embodiment, the bypass oil line communicates with an oil return line in which the bypass oil enters the OCV from the rocker arm, and the oil return line is open by a control of the OCV when the CDA is operated and separated from an oil supply line configured to supply the oil to the rocker arm.

In an embodiment, the oil jet check valve is connected to an oil injection pipe, and the oil injection pipe is connected to an outlet of the oil jet check valve to perform the oil jet injection to a lower portion of the piston.

In an embodiment, the control unit operates the OCV with a CDA ON signal when the CDA is operated, operates the rocker arm by a hydraulic operation due to the oil of a rocker shaft oil line suppled to the rocker arm through an oil supply line that is open by the operation of the OCV, and blocks the bypass oil extension line by the bypass opening by the operation of the OCV to stop an oil jet injection in the oil jet check valve.

In an embodiment, the control unit stops the operation of the OCV with a CDA OFF signal when the CDA is not operated, stops an operation of the rocker arm by blocking an oil supply line due to the non-operation of the OCV to convert the rocker arm into a hydraulic release state, sends the bypass oil discharged from the rocker arm from the OCV to the oil jet check valve by opening the bypass oil extension line by the bypass closing due to the non-operation of the OCV, and performs the oil jet injection by opening the oil jet check valve due to a hydraulic operation of the bypass oil.

The oil jet system according to the present disclosure implements the following operations and effects.

First, the oil jet system can perform the oil injection control that distinguishes between the operation and non-operation of the CDA. Second, the CDA interlocked oil injection variable control can be implemented by using the bypass function of the OCV that bypasses the oil when the CDA is not operated. Third, the oil jet system can reduce the flow rate of the oil used by the oil jet system for oil injection to reduce the capacity of the oil pump of the vehicle, it is possible to improve the fuel efficiency. Fourth, it is possible to prevent the oil-up problem due to the negative pressure in the deactivated cylinder caused by the regular oil injection of the oil jet system without distinguishing between the operation and non-operation of the CDA, thereby improving merchantability of the CDA system and the vehicle.

### BRIEF DESCRIPTION OF THE FIGURES

FIG. 1 is a configuration diagram of a CDA operation interlocked oil jet system according to the present disclosure.

FIG. 2 shows a blocked state of an OCV and the oil jet system when a CDA according to the present disclosure is operated.

FIG. 3 shows a connected state of the OCV and the oil jet system when the CDA according to the present disclosure is not operated.

### DETAILED DESCRIPTION

Hereinafter, embodiments of the present disclosure will be described in detail with reference to the accompanying exemplary drawings, and the embodiments are illustrative and may be implemented in various different forms by those skilled in the art to which the present disclosure pertains, and thus not limited to the embodiments described herein.

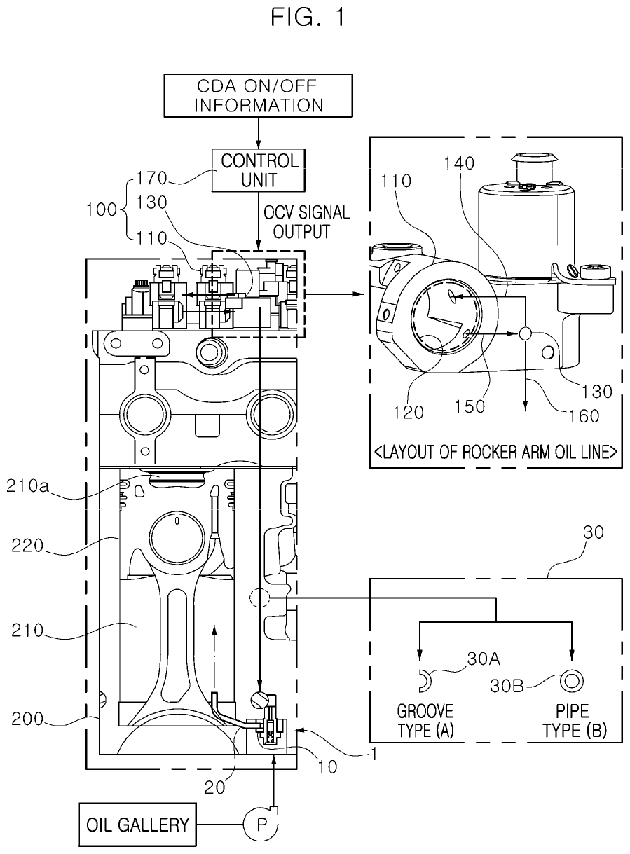

Referring to FIG. 1, an oil jet system 1 includes a bypass oil extension line 30 connected with a cylinder deactivation (CDA) system 100, and the bypass oil extension line 30 is connected with a bypass oil path 160 of an oil control valve (OCV) 130 to send the oil discharged from a rocker pin 120 side of a rocker arm 110 to an oil jet check valve 10 through the OCV 130. In this case, the CDA system 100 mounted on each cylinder of an engine has a method of converting a corresponding cylinder to a deactivated state at operation.

Accordingly, the oil jet system 1 converts a bypass function of the OCV 130 to a bypass closing when the CDA is not operated to open the bypass oil extension line 30 of the oil jet check valve 10 so that the oil jet injection to a piston of the engine is performed, whereas the oil jet system 1 converts the bypass function of the OCV 130 to a bypass opening when the CDA is operated to block the bypass oil extension line 30 and thus is operated so that the oil jet injection is stopped.

The oil jet injection control uses the oil bypass function implemented in the OCV 130 of an internal combustion engine vehicle that implements the CDA system 100, so that the oil jet system 1 is characterized by a CDA operation interlocked oil jet system, which can reduce a capacity of an oil pump and prevent an oil-up phenomenon caused by negative pressure inside the cylinder of the engine by reducing the unnecessary use of the oil when the CDA is operated.

Specifically, the oil jet system 1 includes the oil jet check valve 10, an oil injection pipe 20, the bypass oil extension line 30, the OCV 130, and a control unit 170.

For example, the oil jet check valve 10 performs the oil supply through the bypass oil extension line 30 connected to the OCV 130, and is positioned below a cylinder 210 using a cylinder block of an engine 200. In this case, the position below the cylinder 210 means a space below a piston in which a piston 220 forming a combustion chamber 210a in the cylinder 210 is connected to a connecting rod.

For example, the oil injection pipe 20 injects the oil discharged from the oil jet check valve 10 toward a lower portion of the piston 220, and the other end of the pipe is positioned in an internal space of the cylinder 210 from a bottom of the cylinder 210 toward the lower portion of the piston 220 in a state in which one end of the pipe is connected to an outlet of the oil jet check valve 10. In this case, the oil injection pipe 20 has a bent structure at the other end of the pipe, and performs the oil jet injection upward (i.e., in a direction against gravity).

For example, the bypass oil extension line 30 connects the OCV 130 and the oil jet check valve 10, wherein one end of the line is connected to the OCV 130 and the other end of the line is connected to the oil jet check valve 10 from a cylinder head of the engine 200 through a cylinder block, so that a line section connecting the one end and the other end of the line is formed in a linear length along a cylinder block region where a cylinder head region and the cylinder 120 are not formed. In this case, the line section may be formed in a curved structure or a bent structure according to cross-sectional shapes of the cylinder head and the cylinder block.

In particular, the bypass oil extension line 30 forms a connection path that is connected from the OCV 130 to the oil jet check valve 10 in the cylinder block (or the cylinder head and the cylinder block) of the engine 200, and the connection path is formed in a vertical direction where gravity acts so that the bypass oil freely drops.

In addition, the bypass oil extension line 30 is applied as a groove type structure (A) or a pipe type structure (B), wherein the groove type structure (A) is formed as a cylinder block groove 30A in which the fleshes of the cylinder head and the cylinder block are recessed in a semi-circular cross section to connect the OCV 130 and the oil jet check valve 10, and the pipe type structure (B) is formed as a hollow cross-sectional pipe 30B in which the OCV 130 and the oil jet check valve 10 are connected to each other.

As described above, the bypass oil extension line 30 may be formed directly in the engine 200 as the cylinder block groove 30A or formed as the pipe 30B as a component separately from the engine 200. In this case, the pipe 30B is applied in a method in which an end inserted into the cylinder block is connected to the oil jet check valve 10 in a state of being attached to an outside of the cylinder block of the engine 200 by a bolt or welding.

Specifically, referring to a layout of the rocker arm oil line, the OCV 130 is connected to the rocker shaft oil line to control the oil supply to the rocker pin 120 of the rocker arm 110, and includes an oil supply line 140, an oil return line 150, and a bypass oil line 160.

For example, the oil supply line 140 passes through an inside of the rocker arm 110 from the OCV 130 and is connected to one side of the rocker pin 120 coupled to the rocker arm 110, and sends the oil introduced into the rocker shaft oil line from the OCV 130 to the rocker pin 120 to form a hydraulic circuit when the CDA is operated.

For example, the oil return line 150 is integrally formed on the rocker arm 110 and forms the hydraulic circuit in which the oil discharged from the oil discharge gap of the rocker arm boss to which the rocker pin 120 is axially coupled is returned toward the OCV 130. In this case, the oil return line 150 is positioned in the front of the OCV 130, and the oil returned to the OCV 130 through the oil return line 150 is returned to the oil gallery of the engine or flows toward the piston.

For example, the bypass oil line 160 is connected to the bypass oil extension line 30 via the OCV 130 to form the hydraulic circuit in which the oil returned to the OCV 130 through the oil return line 150 is discharged to the bypass oil extension line 30 through the OCV 130. In this case, the bypass oil line 160 is formed at a right angle with the oil return line 150 with respect to the OCV 130, and operated so that the oil smoothly moves down toward the oil jet check valve 10 by the action of gravity.

As described above, the OCV 130 associates a basic oil bypass function (i.e., a function of bypassing the oil discharged from the rocker arm) with the bypass oil extension line connected to the oil return line 150 and the bypass oil line 160, and interlocks operation states of the bypass oil extension line 30 and the oil supply line 140, so that the oil hydraulic circuit of the OCV 130 may be formed by only the control of the oil supply line 140.

Accordingly, when the CDA is operated, the OCV 130 blocks the oil supply line 140 and the bypass oil extension line 30 by setting the oil bypass function to the bypass opening under the control of the control unit 170, and is operated so that the oil is introduced into the rocker arm 110 in the closed state of the OCV accordingly, so that the oil jet injection of the oil jet check valve 10 may be stopped upon the bypass opening.

On the other hand, when the CDA is not operated, the OCV 130 communicates the oil supply line 140 and the bypass oil extension line 30 by setting the oil bypass function to the bypass closing under the control of the control unit 170, and is operated so that the oil discharged from the rocker arm 110 in the open state of the OCV accordingly is supplied to the oil jet check valve 10 through the bypass oil extension line 30, so that the oil jet injection of the oil jet check valve 10 may be started upon the bypass closing. In this case, the oil jet check valve 10 is changed by the hydraulic operation of the oil supplied from the bypass oil extension line 30 to perform the oil jet injection operation.

For example, the control unit 170 controls the opening/closing of the oil bypass function of the OCV 130 to form an oil supply and blocking circuit for the oil supply line 140. To this end, the control unit 170 generates CDA ON/OFF information based on vehicle traveling conditions or engine control states, and controls the OCV 130 with a CDA ON signal output and a CDA OFF signal output depending on whether the CDA is controlled. In this case, the control unit 170 may be a separate dedicated control unit but may be an engine control unit.

Specifically, the cylinder deactivation (CDA) system 100 includes the rocker arm 110 formed in a structure that is divided into an inner rocker arm and an outer rocker arm, the rocker pin 120, and the OCV 130.

For example, the rocker arm 110 couples the rocker pin 6 with the rocker arm boss to perform the operation and non-operation of the CDA, and the rocker arm 110 converts the corresponding cylinder into the deactivated state with the lost motion (i.e., separation of the inner rocker arm and the outer rocker arm) according to the disengaged state of the rocker pin 120 when the CDA is operated, whereas the rocker arm 110 converts the corresponding cylinder into the combustion state with the return to the initial position (i.e., connection between the inner rocker arm and the outer rocker arm) according to the engaged state of the rocker pin 120 when the CDA is not operated. In this case, the cam of the camshaft is positioned below one end of the rocker arm 110, and the engine bridge configured to operate engine valves (i.e., an intake valve and an exhaust valve) mounted on the cylinder of the engine is positioned below the other end of the rocker arm 110.

For example, the rocker pin 120 is comprised of a latch pin positioned at the right of the inner pin of the rocker arm 110 and an actuation piston positioned at the left thereof and arranged on the rocker arm boss in series, wherein the actuation piston is moved by the hydraulic operation of the oil supplied from the oil supply line 140 by connecting the oil supply line 140 to form the leftward movement (i.e., pin disengaged state) of the inner pin, and when the hydraulic pressure is released by blocking the oil of the oil supply line 140, the latch pin is moved by a spring restoring force to form the rightward movement (i.e., pin engaged state) of the inner pin.

For example, as described above, the OCV 130 forms the oil hydraulic circuit with the oil supply line 140, the oil return line 150, and the bypass oil line 160, and connects the bypass oil line 160 to the bypass oil extension line 30.

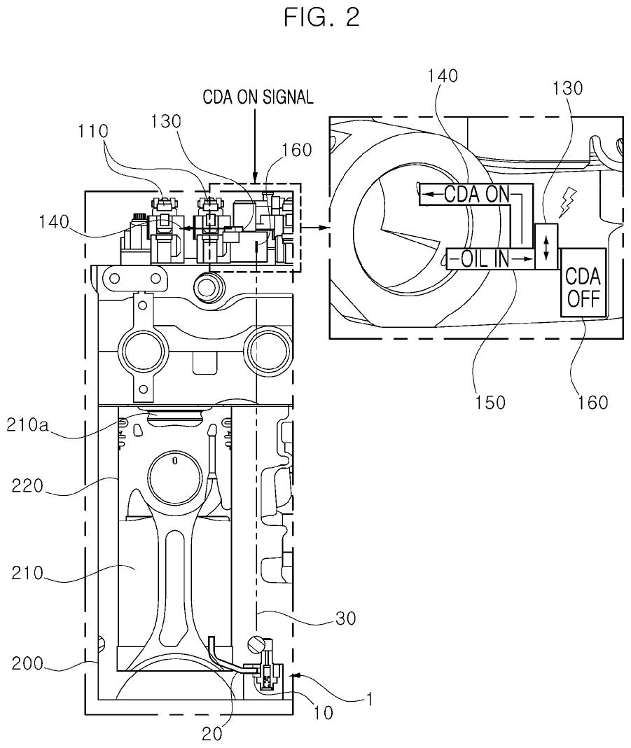

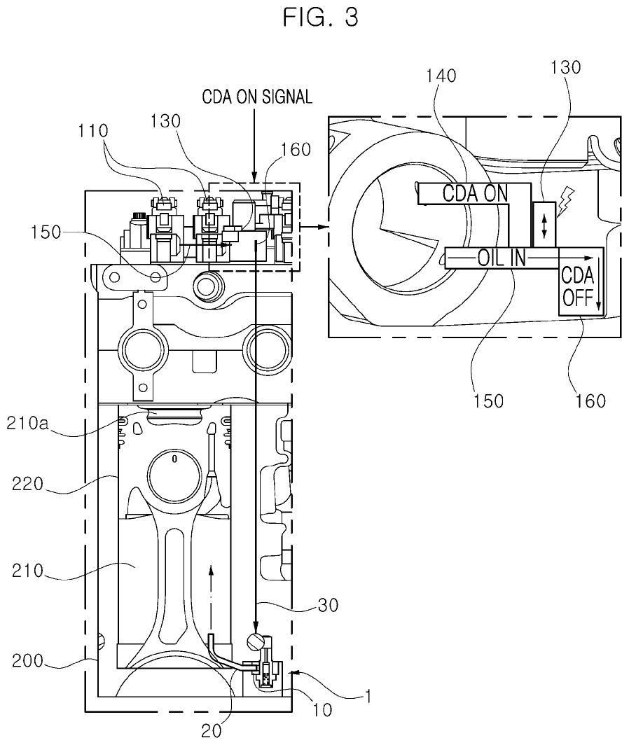

Meanwhile, FIGS. 2 and 3 show a state in which the OCV 130 and the oil jet system 1 are interlocked according to the operation and non-operation of the CDA.

Referring to the operation of the CDA in FIG. 2, when the CDA is operated by the CDA ON signal of the control unit 170, the OCV 130 converts the oil bypass function into the bypass opening to open the oil supply line 140 so that the bypass oil line 160 is blocked, so that the oil supplied from the rocker shaft oil line of the rocker arm 110 is supplied from the right of the rocker arm 110 toward the rocker pin 120 (i.e., the actuation piston) through the OCV 130 and the oil supply line 140.

Accordingly, the hydraulic pressure acts on the rocker pin 120 by opening the oil supply line 140 according to the open state of the OCV 130, and the lost motion occurs in the rocker arm 110 in the pin disengaged state due to the hydraulic operation, so that the corresponding cylinder is converted into the deactivated state. In this case, the lost motion of the rocker arm 110 is a state in which the inner rocker arm, which is initially in the connected state, is separated from the outer rocker arm.

At the same time, the operation of the CDA through the open state of the OCV 130 blocks the communication state between the bypass oil extension line 30 and the bypass oil line 160, so that the oil returned to the OCV 130 through the oil return line 150 may not be discharged to the bypass oil extension line 30, and thus the oil jet check valve 10 maintains the closed state as it is by not forming the oil hydraulic pressure required for change.

As a result, the operation of the CDA makes the CDA system 100 be in an operation state by supplying oil through the oil supply line 140, whereas making the oil jet system 1 be in a non-operation state by not supplying the oil due to the closing of the bypass oil extension line 30.

As described above, in the operation of the CDA, the oil jet system 1 and the CDA system 100 are operated in the order of “(1) operation of the OCV->(2) oil supply to the rocker shaft oil line->(3) operation of the rocker arm->(4) no oil supply to the oil jet check valve->(5) no oil jet injection”. In this case, “->” is the proceeding order of the operation.

Accordingly, the oil jet system 1 does not perform the oil jet injection due to the oil jet check valve 10 that fails to form the oil hydraulic pressure required for change when the CDA is operated, and the oil jet non-injection reduces the unnecessary use of the oil, so that it is possible to improve fuel efficiency due to the reduction in the capacity of the pump and improve merchantability according to the prevention of the oil-up phenomenon due to the internal negative pressure of the cylinder.

On the other hand, referring to the non-operation or stoppage of the CDA in FIG. 3, when the CDA is turned off by the CDA OFF signal of the control unit 170, the OCV 130 converts the oil bypass function into the bypass closing to block the oil supply line 140 so that the bypass oil line 160 is open, so that the OCV 130 and the oil jet system 1 form the connected state.

Accordingly, the blocking of the oil supply line 140 according to the closed state of the OCV 130 converts the corresponding cylinder to the combustion state by releasing the hydraulic pressure to return the rocker pin 120 and the rocker arm 110 to the initial positions, and at the same time, in the communication state between the bypass oil line 160 and the bypass oil extension line 30 according to the closed state of the OCV 130, the OCV 130 connects the oil return line 150, the bypass oil line 160, and the bypass oil extension line 30, so that the oil returned to the OCV 130 through the oil return line 150 is discharged to the bypass oil extension line 30 through the bypass oil line 160.

Then, the bypass oil extension line 30 sends the oil to the oil jet check valve 10, so that the oil jet check valve 10 that receives the oil hydraulic pressure required for change is converted into an open state, and the oil is discharged from the oil jet check valve 10 and injected by the oil jet from the bottom of the cylinder 210 toward the lower portion of the piston 220 in the oil injection pipe 20.

As a result, the stoppage/non-operation of the CDA makes the oil jet system 1 be in the operation state in the non-operation state of the CDA device 100 by forming the oil supply path of the bypass oil extension line 30 when the oil returns through the oil return line 150.

As described above, in the non-operation of the CDA, the oil jet system 1 and the CDA system 100 are operated in the order of “(1) the non-operation of the OCV->(2) no oil supply to the rocker shaft oil line->(3) non-operation of the rocker arm->(4) the oil supply to the oil jet check valve->(5) the oil jet injection”. In this case, “->” is the proceeding order of the operation.

As described above, the CDA operation interlocked oil jet system 1 according to this embodiment connects the OCV 130 for supplying the oil for the operation of the CDA of the rocker arm 3 and the oil jet check valve 10 configured to perform the oil jet injection toward the piston 220 of the engine 200 by the bypass oil extension line 30, and includes the control unit 170 configured to convert the bypass function of the OCV 8 into opening and closing so that the bypass oil extension line 30 blocked when the CDA is not operated is open when the CDA is operated, so that it is possible to control the oil jet injection by dividing the bypass function of the OCV into the operation and non-operation of the CDA to use the bypass function of the OCV accordingly, and in particular, the oil jet injection to the cylinder is performed when the CDA is not operated, and then stopped in the deactivated cylinder that occurs when the CDA is operated, so that it is possible to prevent the oil-up phenomenon and reduce the capacity of the oil pump by reducing or blocking the unnecessary injection oil of the oil jet.

While a number of exemplary aspects and embodiments have been discussed above, those of skill in the art will recognize that still further modifications, permutations, additions and sub-combinations thereof of the features of the disclosed embodiments are still possible. It is therefore intended that the following appended claims and claims hereafter introduced are interpreted to include all such modifications, permutations, additions and sub-combinations as are within their true spirit and scope.

1. An oil jet system comprising:
an oil jet check valve configured to perform an oil jet injection toward a piston of an engine;
a bypass oil extension line connecting the oil jet check valve to an oil control valve (OCV) configured to supply oil to a rocker arm, and configured to send bypass oil discharged from the OCV to the oil jet check valve by a bypass function conversion of the OCV; and
a control unit configured to control the OCV so that the bypass oil extension line is blocked by a bypass opening of the OCV when a cylinder deactivation (CDA) of the rocker arm is operated, and control the OCV so that the bypass oil extension line is open by a bypass closing of the OCV when the CDA is not operated.

2. The oil jet system of claim 1, wherein the bypass oil extension line is connected to a bypass oil line through which the bypass oil is discharged from the OCV.

3. The oil jet system of claim 2, wherein the bypass oil extension line forms a connection path connected from the OCV to the oil jet check valve in a cylinder block of the engine.

4. The oil jet system of claim 3, wherein the connection path is formed in a vertical direction so that the bypass oil freely drops due to gravity.

5. The oil jet system of claim 3, wherein the bypass oil extension line is formed in a semi-circular cross-sectional cylinder block groove or a hollow cross-sectional pipe.

6. The oil jet system of claim 5, wherein the cylinder block groove is formed in a structure integrated with the cylinder block by being recessed in the cylinder block of the engine.

7. The oil jet system of claim 5, wherein the pipe is a separate component connected to the oil jet check valve outside the engine.

8. The oil jet system of claim 2, wherein the bypass oil line communicates with an oil return line in which the bypass oil enters the OCV from the rocker arm.

9. The oil jet system of claim 8, wherein the oil return line is opened by a control of the OCV when the CDA is operated, and separated from an oil supply line configured to supply the oil to the rocker arm.

10. The oil jet system of claim 1, wherein the oil jet check valve is connected to an oil injection pipe, and
the oil injection pipe is connected to an outlet of the oil jet check valve and configured to perform the oil jet injection to a lower portion of the piston positioned in a combustion chamber of the engine.

11. The oil jet system of claim 1, wherein the control unit operates the OCV with a CDA ON signal when the CDA is operated,
operates the rocker arm by a hydraulic operation due to the oil of a rocker shaft oil line suppled to the rocker arm through an oil supply line that is open by the operation of the OCV, and
blocks the bypass oil extension line by the bypass opening by the operation of the OCV to stop an oil jet injection in the oil jet check valve.

12. The oil jet system of claim 11, wherein the control unit stops the operation of the OCV with a CDA OFF signal when the CDA is not operated,
stops an operation of the rocker arm by blocking an oil supply line due to the non-operation of the OCV to convert the rocker arm into a hydraulic release state,
sends the bypass oil discharged from the rocker arm from the OCV to the oil jet check valve by opening the bypass oil extension line by the bypass closing due to the non-operation of the OCV, and performs the oil jet injection by opening the oil jet check valve due to a hydraulic operation of the bypass oil.
